(19) United States
(12) Patent Application Publication
(10) Pub. No.: US 2026/0036186 A1
(43) Pub. Date: Feb. 5, 2026

(54) DRIVETRAIN, DRIVE DEVICE AND AGRICULTURAL MACHINE HAVING SAME

(71) Applicant: DEERE & COMPANY, MOLINE, IL (US)

(72) Inventors: JAVIER JOSE PEREZ RAMIREZ, PINTO (ES); DANIEL VERGARA MARTINEZ, Madrid (ES); JUAN ANTONIO TORRES, Madrid (ES)

(21) Appl. No.: 19/257,792

(22) Filed: Jul. 2, 2025

(30) Foreign Application Priority Data
Jul. 31, 2024 (EP) 24191950.5

(51) Int. Cl. F16H 1/22; A01F 12/56; F16D 1/10; F16D 1/108

(52) U.S. Cl. CPC F16H 1/222; A01F 12/56; F16D 1/108; F16D 2001/103

(57) ABSTRACT

A drivetrain comprises an input shaft, a hollow shaft connected in terms of drive to the input shaft, and a bevel gear stage connected in terms of drive to the hollow shaft. The bevel gear stage comprises a driving bevel gear and a driven bevel gear. The driving bevel gear has a gear hub having an internal toothing which meshes with a first external toothing region extending axially on the hollow shaft. The first external toothing region is formed on a first connecting region of the hollow shaft. A rotation-transmitting region of the hollow shaft extends to axially adjoin the first connecting region. The rotation-transmitting region forms a rotationally conjoint connection in terms of drive between the input shaft and the first connecting region. The first connecting region is equipped, between the rotation-transmitting region and the external toothing region, with a first recess that defines a predetermined breaking point.

### CROSS-REFERENCE TO RELATED APPLICATIONS

This application claims priority to European Patent Application No. 24191950.5, filed Jul. 31, 2024, which is hereby incorporated by reference.

### TECHNICAL FIELD

The present disclosure relates generally to drivetrain for a drive device and an agricultural machine having at least one processing device for processing a crop and having the drive device, which is connected to the at least one processing device.

### BACKGROUND

Agricultural machines, in particular harvesting machines having processing devices for a crop that is picked up, are known from the prior art. Such agricultural machines include, for example, combine harvesters, forage harvesters or sugar cane harvesters, or other harvesting machines that have a facility, within the machine, for processing a crop that is picked up. It is thus possible for a threshing processing operation, chopping processing operation, cutting processing operation or some other type of processing operation to be provided in the crop flow during the harvesting of the crop, a drive device being provided for the processing device, which drive device may be equipped with an overload safeguard for safeguarding against overloading. The overload safeguard may be implemented by a torsion safeguard in the form of shear bolts, by a slipping clutch, or by some other means. The use of a slipping clutch is generally disadvantageous owing to a complex construction and susceptibility to wear. An arrangement of shear bolts also requires cumbersome maintenance work. If the shear bolts shear owing to overloading of the drive device, maintenance is generally very cumbersome and generally requires that the drive device be dismounted and the shear bolts exchanged. In particular, the dismounting of the drive device can be expensive and very time-consuming.

Such a harvesting machine is disclosed for example in U.S. Pat. No. 4,248,249 A. Said document describes an axial-flow combine harvester having a cutting attachment for cutting and feeding a crop. The crop is fed in the form of cut material to a threshing and separating system, the system comprising a housing, in which the cut material is received, and a rotor in the housing for threshing and separating the grains from the cut material. The rotor has a rotor axle which is driven by a gearbox in the rear region of the rotor, the gearbox comprising an input shaft and an output shaft, the latter of which drives the rotor. The gearbox is poorly accessible in any case, and shearing of a shear pin as an overload safeguard provided in the transmission would require the gearbox to be completely dismounted for the purposes of repair and maintenance.

A further such harvesting machine is disclosed in EP 3 501 260 A1, which describes a processing device for a crop and a drivetrain for the at least one processing device. The drivetrain has at least one output gearbox stage having a driven shaft for the at least one processing device, the output gearbox stage comprising an input toothed gear and a grooved shaft connected rotationally conjointly to the input toothed gear and to the driven shaft. The connection in terms of drive between the input toothed gear and the output shaft is realized via the grooved shaft. The grooved shaft is equipped with an annular groove which defines a predetermined breaking point, the annular groove being formed between the input toothed gear and the driven shaft in the direction of the flow of drive power, and the grooved shaft being accessible, at the side of the input toothed gear, through an installation opening. The installation opening is formed, in axial alignment with the grooved shaft, on a housing wall that surrounds the drivetrain. Although it was possible here to achieve a considerable reduction in maintenance effort in the event of overloading of the drivetrain, the dismounting and exchange of the grooved shaft remains cumbersome and time-consuming.

### SUMMARY

According to an aspect of the present disclosure, a drivetrain for a drive device, comprises an input shaft, a hollow shaft connected in terms of drive to the input shaft, and a bevel gear stage connected in terms of drive to the hollow shaft. The bevel gear stage comprises a driving bevel gear and a driven bevel gear. The driving bevel gear has a gear hub having an internal toothing which meshes with a first external toothing region extending axially on the hollow shaft. The first external toothing region is formed on a first connecting region of the hollow shaft, and a rotation-transmitting region of the hollow shaft extends so as to axially adjoin the first connecting region. The rotation-transmitting region forms a rotationally conjoint connection in terms of drive between the input shaft and the first connecting region. The first connecting region is equipped, between the rotation-transmitting region and the external toothing region, with a first recess that defines a predetermined breaking point.

According to an aspect of the present disclosure, an agricultural machine comprises at least one processing device for processing a crop and a drive device connected to the at least one processing device. The drive device includes aforementioned drivetrain.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a schematic cross-sectional side view of a harvesting machine in the form of a combine harvester having processing devices and having a drive device provided for said processing devices.

FIG. 2 is a schematic cross-sectional plan view of the harvesting machine from FIG. 1.

FIG. 3 is an enlarged schematic cross-sectional view of the drive device for the processing devices from FIGS. 1 and 2, with a gearbox housing.

FIG. 4 is an enlarged schematic plan view of the drive device from FIG. 3, without a gearbox housing,

FIG. 5 is an enlarged schematic cross-sectional view of a part of the drive device from FIG. 3, and

FIG. 6 is an enlarged schematic cross-sectional view of one of the hollow shafts of the drive device from FIGS. 1 to 5. Like reference numerals are used to indicate like elements throughout the several figures.

### DETAILED DESCRIPTION

The object on which the disclosure is based is considered that of specifying a drivetrain of the type mentioned in the introduction, by means of which the aforementioned problems are overcome.

The object is achieved according to the disclosure by the teaching of one or more embodiments disclosed herein. Further advantageous embodiments and developments of the disclosure can be found in the one or more embodiments disclosed herein.

According to the disclosure, a drivetrain of the type mentioned in the introduction is provided, the first external toothing region being formed on a first connecting region of the hollow shaft, and a rotation-transmitting region of the hollow shaft extending so as to axially adjoin the first connecting region. The rotation-transmitting region forms a rotationally conjoint connection in terms of drive between the input shaft and the first connecting region, the first connecting region being equipped, between the rotation-transmitting region and the external toothing region, with a first recess that defines a predetermined breaking point. The recess serves as an overload safeguard and, in the event of overloading of the drivetrain, leads to a desired breakage in the connecting region of the hollow shaft, between the external toothing region and the rotation-transmitting region. By means of a corresponding design of the recess in the connecting region, a maximum admissible load can be set or defined, for example by way of a corresponding shape, extent and depth of the recess, which reduces or weakens a hollow shaft cross section that is subjected to load when torque is transmitted. When a particular load or a particular torque is reached or exceeded, a preferential predetermined breakage occurs in the connecting region at the location of the recess, or a breakage of the hollow shaft occurs, and the external toothing region shears away from the rotation-transmitting region. The hollow shaft is a structurally simple and easily accessible component which, in terms of drive, is mounted on the input shaft at the start of the drivetrain. Thus, in the event of overloading of the drivetrain or if the hollow shaft breaks or shears, a necessary maintenance measure or repair measure can be carried out with little assembly effort and in a short time.

In an embodiment of the disclosure, the hollow shaft comprises a second external toothing region that is not connected in terms of drive to the driving bevel gear, the first and the second external toothing region having the same module. This means that the external toothing regions are of identical design in terms of their tooth shape, number of teeth, pitch circle diameter and other geometrical tooth variables. The second external toothing region is formed on a second connecting region of the hollow shaft, which second connecting region also extends so as to axially adjoin the rotation-transmitting region, such that the rotation-transmitting region of the hollow shaft extends axially between the first and the second connecting region, the rotation-transmitting region forming a rotationally conjoint connection in terms of drive between the input shaft and the two connecting regions. The first connecting region is equipped, between the rotation-transmitting region and the first external toothing region, with the first recess that defines a predetermined breaking point. The second connecting region is correspondingly equipped, between the rotation-transmitting region and the second external toothing region, with a second recess that defines a predetermined breaking point. The formation of a second external toothing region on the same hollow shaft, and of a second recess in the second connecting region, makes it possible, in the event of overloading of the drive unit or if the hollow shaft breaks or shears, for the same hollow shaft to be used again by virtue of said hollow shaft being rotated through 180° and installed onto the input shaft, and drive then being transmitted via the second external toothing region. The hollow shaft can thus be used for a first and a second time, with the overload safeguard being maintained. A maintenance or repair measure can thus be carried out even without exchanging the hollow shaft that is used. Only if overload-induced damage occurs again would it be necessary to finally exchange and replace the hollow shaft. In the initial state of the hollow shaft, that is to say for as long as the hollow shaft has not yet sustained overload damage and both external toothing regions are intact, the second external toothing region is not connected in terms of drive, and rotates concomitantly without any drive function.

The recess may be formed as an annular groove which extends over part or all of the circumference of the particular connecting region. It is conceivable for the annular groove to be formed on the internal circumference or on the external circumference of the connecting region of the hollow shaft. In both cases, the cross section of the connecting region is reduced at this location, giving rise to the desired predetermined breaking point or predetermined shearing point on the hollow shaft. By means of the depth of the annular groove, it is possible to influence the extent to which the cross section is reduced or weakened, and thus in turn to set or define the maximum forces and torques that can be transmitted without the hollow shaft shearing or breaking, or before the hollow shaft shears or breaks. Accordingly, the hollow shaft is intended to form the weakest link or the weakest drive component in the drivetrain in order that, in the event of overloading, damage to other expensive and poorly accessible drive components, or to expensive processing devices that are driven by means of such a drivetrain, such as threshing drums, chopping drums or cutting rotors and the like, is avoided.

In one embodiment of the disclosure, the hollow shaft may have, in the rotation-transmitting region, an internal profile that engages with a complementary external profile of the input shaft. For example, the hollow shaft is equipped with an internal hexagonal profile and the input shaft is equipped with an external hexagonal profile, the internal profile of the hollow shaft being mounted on the external profile of the input shaft, and a rotational connection thus being produced. The profiles may take various forms and, instead of edge profiles, may for example also have internal and external grooves or else internal toothings and external toothings, by means of which a rotationally conjoint connection between the input shaft and the hollow shaft can be achieved.

In the first and/or second connecting region of the hollow shaft, a circumferential gap is formed between the internal circumference of the particular connecting region and the external circumference of the input shaft. The circumferential gap serves to provide an adequate clearance between the connecting region and the input shaft. It is thus ensured that, in the event of an overloading-induced breakage of the hollow shaft or if the connecting region shears away from the rotation-transmitting region, the connecting region that has sheared away can rotate freely relative to the input shaft, and any connection in terms of drive is eliminated.

The hollow shaft can be secured axially on the input shaft by means of an axially variably positionable stop ring in the form of a clamping ring. The clamping ring serves to axially fix the hollow shaft on the input shaft, the clamping ring being formed for example as a clamping ring and being fixed releasably on the input shaft by means of a clamping screw. On the opposite side of the hollow shaft, said hollow shaft may bear against a stop formed on the driving bevel gear or against a circlip or securing ring situated internally in the driving bevel gear, such that the hollow shaft can be fixed on the input shaft in both directions.

The drivetrain may furthermore comprise a transmission gearbox that is connected in terms of drive to the driven bevel gear of the bevel gear stage. The transmission gearbox may for example be formed, in the drivetrain, as an output gearbox stage for a processing device, and may comprise a driven shaft for the processing device. The transmission gearbox may however also be arranged as an intermediate gearbox in the drivetrain, and may be provided as a further preliminary stage for the drive of the processing device.

The drivetrain may be formed such that both the hollow shaft and the input shaft are accessible from outside a gearbox housing, with the bevel gear stage and other drivetrain components situated downstream in the flow of drive power being accommodated in the gearbox housing. Should overloading of the drivetrain occur, then maintenance measures and/or repair measures that require dismounting and/or replacement of the hollow shaft can be carried out without cumbersome dismounting of the gearbox housing.

The above-described examples for a drivetrain may, from a design aspect, be used individually or severally in one drive concept, in particular in one drive device. For example, a drive device may comprise one or more drivetrains, likewise in combination with one another, such that, for example, a component of a drivetrain is included functionally, or in terms of drive, in parallel in a plurality of drivetrains.

For example, a drive device may comprise a first and a second drivetrain according to example embodiments described above, the input shaft being formed as a common input shaft and being used as a driving component both in the first and in the second drivetrain. Thus, a drive device having a first and a second drivetrain can be operated, in accordance with the drivetrains described above, using one and the same input shaft. With such a drive device, it is for example possible for two processing devices, each having a drivetrain and each having a hollow shaft assigned to the drivetrain as an overload safeguard, to be operated in parallel, with the two processing devices each being equipped with mutually independent overload safeguards owing to the separate hollow shafts.

An agricultural machine may for example be equipped with one or more processing devices for processing a crop, with the processing device, or each of the plurality of processing devices, being driven by means of a drivetrain according to the examples described above. An agricultural machine may in particular have a drive device that has a first and a second drivetrain according to the possible embodiments described above. Such agricultural machines may be, for example, combine harvesters, corn pickers, forage harvesters, mowing machines, or other types of harvesting machines.

As already mentioned, the agricultural machine may comprise one or more processing devices, which may be designed for example as chopping devices, cutting devices, or threshing devices. It is possible for a plurality of processing devices, for example two mutually adjacently arranged threshing drums or threshing rotors, to be operated in parallel. It may be expedient to provide drive devices having separate drivetrains, operated in parallel, for each processing device, or for example to provide one drive device having only one drivetrain, which is connected to a branching gearbox for the purposes of driving a plurality of processing devices.

The disclosure and further advantages and advantageous developments and embodiments of the disclosure will be described and explained in more detail below with reference to the drawing, which shows an example embodiment of the disclosure.

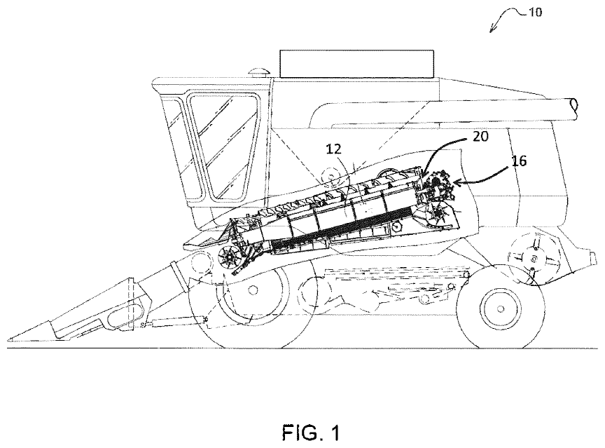

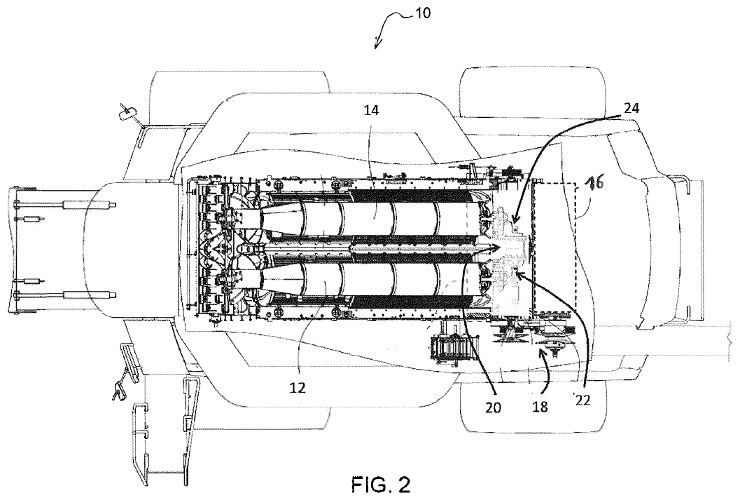

FIG. 1 and FIG. 2 show a self-propelled agricultural machine 10, configured by way of example in the form of a combine harvester. It is also conceivable for the example embodiment described in more detail below to be implemented on some other type of self-propelled agricultural machine, for example a forage harvester, a mowing machine, or a sugar cane harvester.

The agricultural machine 10 has a first and a second processing device 12, 14 in the form of axial threshing rotors oriented in the longitudinal direction of the agricultural machine 10. The agricultural machine 10 is driven by an internal combustion engine 16 (illustrated merely schematically). The internal combustion engine 16 drives a belt drive 18, which in turn drives a drive device 20 for the aforementioned processing devices 12, 14. The drive device 20 comprises a first drivetrain 22, which is assigned to the first processing device 12, and a second drivetrain 24, which is assigned to the second processing device 14.

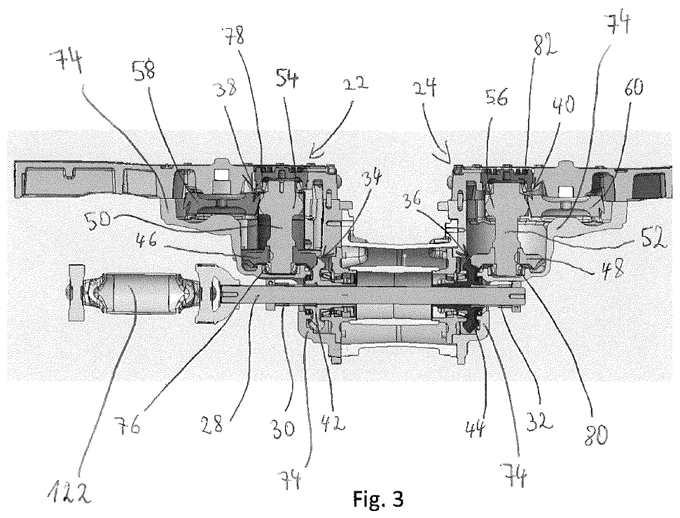

As can be seen in more detail in FIGS. 3 to 5, the first and the second drivetrain 22, 24 not only comprise a common input shaft 28 but also each comprise, inter alia, a hollow shaft 30, 32, a bevel gear stage 34, 36 and a transmission gearbox 38, 40. Each of the bevel gear stages 34, 36 comprises a driving bevel gear 42, 44, which is driven by the associated hollow shaft 30, 32, and a driven bevel gear 46, 48. Each driven bevel gear 46, 48 is connected in terms of drive to the associated transmission gearbox 38, 40, and in each of the transmission gearboxes 38, 40 there are provided an input toothed gear 54, 56, which is connected to the associated driven bevel gear 46, 48 via a common shaft 50, 52, and an output toothed gear 58, 60. Each output toothed gear 58, 60 is connected to an output shaft 62, 64 that drives the associated processing device 12, 14.

The driving bevel gears 42, 44 are each supported via two roller bearings 66, 68 and 70, 72 on a multi-part gearbox housing 74 that surrounds the drive device 20. The driven bevel gears 46, 48 and the input toothed gears 54, 56 are fastened to the associated common shafts 50, 52, which are each in turn supported via two roller bearings 76, 78 and 80, 82 on the gearbox housing 74. In each case two further roller bearings 84, 86 and 88, 90 supported on the gearbox housing 74 are provided for supporting the output shafts 62, 64 connected to the output toothed gears 58, 60.

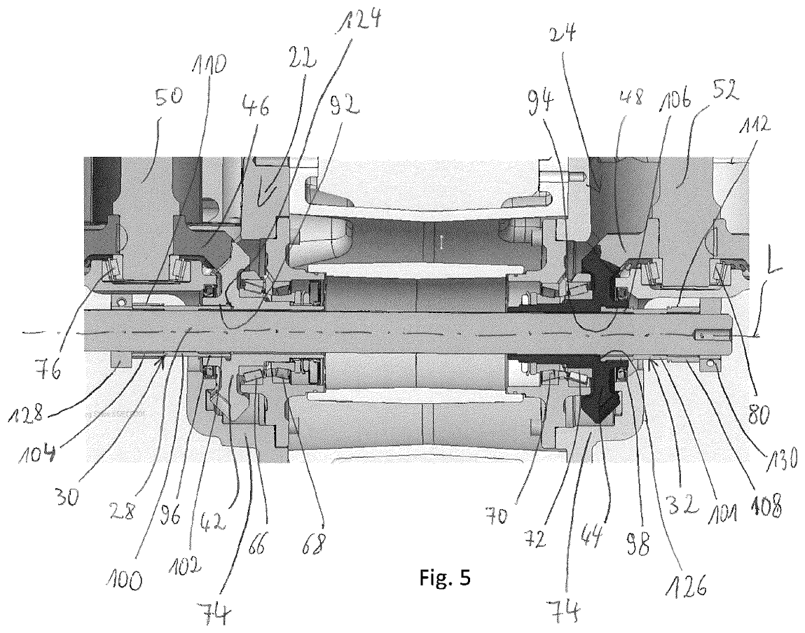

As can be seen in detail in FIG. 5, the driving bevel gears 46, 48 are each equipped, at the front, with an internal toothing 92, 94 that meshes in each case with an external toothing 96, 98 formed on the hollow shafts 30, 32.

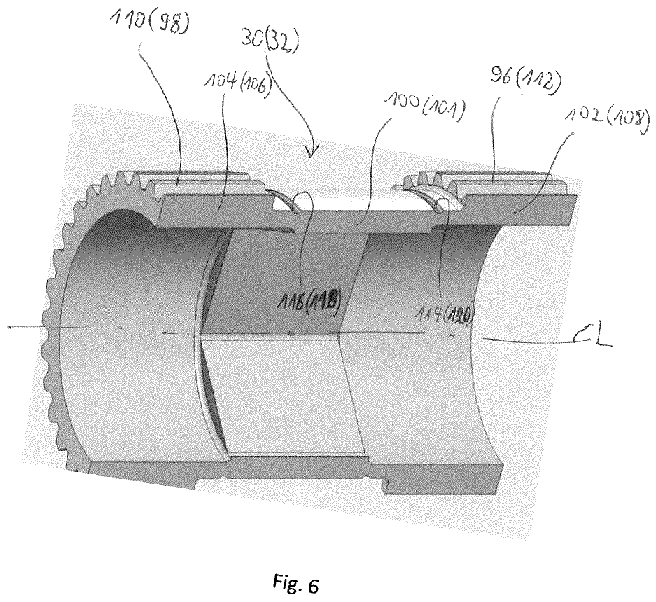

Further details of the hollow shafts 30, 32, which are structurally identical, are apparent from FIG. 6, which shows a cross-sectional view of the hollow shafts 30, 32 assigned to the drivetrains 22, 24; the reference signs in parentheses relate to the hollow shaft 32 of the second drivetrain 24. The hollow shafts 30, 32 each have a rotation-transmitting region 100, 101 that is formed with an internal hexagonal profile. The rotation-transmitting region 100, 101 is adjoined to both sides in the longitudinal direction L of the hollow shaft 30, 32 by connecting regions 102, 104 or 106, 108. The aforementioned external toothings 96 and 98, which mesh with the internal toothings 92, 94 of the driving bevel gears 42, 44, are formed on the connecting regions 102 and 106. A further external toothing 110 and 112 is formed on each of the opposite connecting regions 104 and 108, which external toothings 110 and 112 run freely or are not in meshing engagement, and in the situation and position illustrated in the figures do not contribute to a transmission of drive power. A recess in the form of an annular groove 114, 116 and 118, 120 is formed, adjacent to the rotation-transmitting region 100, 101, on the outside of the connecting regions 102, 104 and 106, 108. The annular grooves 114, 116 and 118, 120 each form, adjacent to the rotation-transmitting region 100, 101, a cross-sectional reduction of the hollow shaft 30, 32, which may be more or less pronounced depending on a depth of the particular annular groove 114, 116 and 118, 120. The remaining cross section of the hollow shaft 30, 32 in the region of the particular annular groove 114, 116 and 118, 120 thus limits a maximum torque that can be transmitted via the rotation-transmitting region 100, 101 to the connecting regions 102, 106 and 106, 108 and from there via the external toothings 96, 98 and 110, 112. Should overloading of the drivetrain 22, 24 occur, a breakage occurs at the smallest cross section of the hollow shaft. This means that, for the drivetrains 22, 24 illustrated in FIGS. 3 to 5, a desired hollow shaft breakage occurs in the region of the annular groove 114 for the first drivetrain 22 and in the region of the annular groove 118 for the second drivetrain 24, or the affected connecting region 102 or 106 shears, if a maximum specified torque is exceeded. The maximum torque that can be transmitted can be specified through corresponding configuration of the annular grooves (in particular of the depth), and dimensioned such that the other drive components arranged in the drivetrain 22, 24 are designed for a load exceeding the maximum torque, and remain protected against damage. In other words, the annular grooves 114, 116, 118, 120 formed on the hollow shafts 30, 32 form predetermined breaking points on the hollow shafts 30, 32, which predetermined breaking points interrupt the flow of drive power in the event of overloading of the drivetrains 22, 24, without more severe damage being done to other, more expensive drive components that are difficult to access.

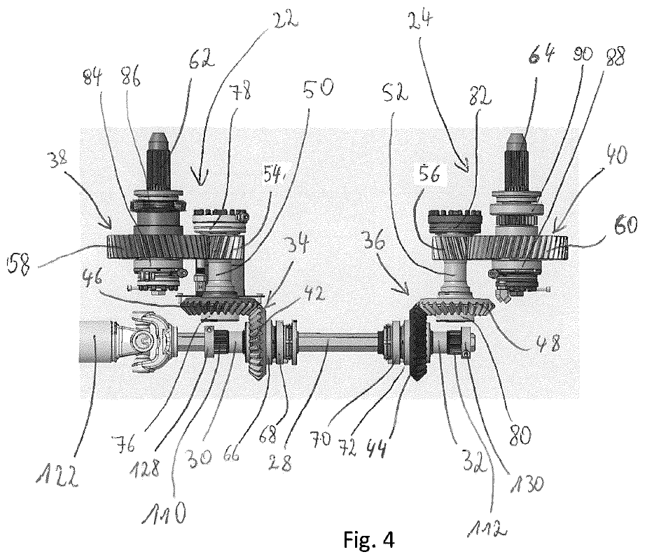

As illustrated in FIGS. 3 and 4, the input shaft 28 is coupled to, and driven via, a universal joint 122. The universal joint 122 is connected at the driving side to the belt drive 18. The input shaft 28 is formed with an external hexagonal profile (see FIG. 4) and is connected in terms of drive to the two hollow shafts 30, 32, the external hexagonal profile of the input shaft 28 engaging with the internal hexagonal profile of the hollow shafts 30, 32. As already mentioned, the external toothings 96 and 98 are connected in terms of drive to the respective internal toothings 92 and 94 of the driving bevel gears 42 and 44, and the hollow shafts 30, 32 are each fixed axially in the longitudinal direction (along the longitudinal axis L) in the direction of the associated driving bevel gear 42, 44 by a stop 124, 126 formed on the associated driving bevel gear 42, 44. In the opposite direction along the longitudinal axis L in each case, the two hollow shafts 30, 32 are fixed axially by in each case one clamping ring 128, 130. The clamping rings 128, 130 are axially fixed by means of clamping screws. By virtue of the clamping screws being released, the clamping rings 128, 130 can be moved or displaced in the axial direction on the input shaft 28.

As already described above, the hollow shafts 30, 32 each constitute an overload safeguard, the hollow shaft 30 safeguarding the first drivetrain 22 and the hollow shaft 32 safeguarding the second drivetrain 24. Consequently, should overloading of the drivetrains 22, 24 occur or a maximum admissible drive torque be exceeded, for example in the event of an excessive crop inflow or in the event of overloading or blockage of one or both processing devices 12, 14, then this would cause the hollow shaft 30, 32 of the respectively affected drivetrain 22, 24 to break or shear. A repair or maintenance measure for the one or more affected drivetrains 22, 24 can be carried out particularly easily and in a time-saving manner by virtue of the hollow shaft 30, 32 of the affected drivetrain 22, 24 being rotated through 180°, such that the external toothing 110, 112 that was hitherto not connected in terms of drive is connected in terms of drive to the internal toothing 92 or 94 of the driving bevel gears 42 and 44. The correspondingly sheared-off end of a hollow shaft 30, 32 that was previously connected in terms of drive to the drive bevel gears 42, 44 is removed. Altogether, a distinction can be made between three cases in which a repair or maintenance measure is carried out, as follows: Overloading of the first drivetrain 22; overloading of the second drivetrain 24; or overloading of both drivetrains simultaneously. In these cases, the first hollow shaft 30, the second hollow shaft 32, or both hollow shafts 30, 32 simultaneously, break(s) or shear(s).

In the first case, that is to say if the first hollow shaft 30 breaks or shears, it is necessary in a first step for the first clamping ring 128 to be loosened or released from the input shaft 28, such that the input shaft 28 can be decoupled from or pulled off the universal joint 122 in the longitudinal direction L. The input shaft 28 is pulled off to such an extent that the clamping ring 128, the connecting region 104 of the first hollow shaft 30 having the external toothing 110 formed thereon, together with the rotation-transmitting region 100 of the first hollow shaft 30 and the broken/sheared connecting region 102 of the first hollow shaft 30 having the external toothing 96 formed thereon, are released from the input shaft 28. The broken/sheared connecting region 102 of the first hollow shaft 30 having the external toothing 96 formed thereon can then be removed. In the next step, the remaining part of the first hollow shaft 30 is rotated through 180 degrees such that the external toothing 110 formed on the connecting region 104 is brought into meshing engagement with the internal toothing 92 of the first driving bevel gear 42. Then, the input shaft is introduced again into the first hollow shaft 30, the clamping ring 128 is mounted, and the input shaft 28 is coupled to the universal joint 122. Once the clamping ring 128 has been repositioned so as to abut against the first hollow shaft 30, and said clamping ring has been fastened in the new position, the first drivetrain 22 has been restored and is operational again.

In the second case, which is to say if the second hollow shaft 32 breaks or shears, it is necessary in a first step for the second clamping ring 130 to be loosened or released and pulled off from the input shaft 28. In a further step, the connecting region 108 of the second hollow shaft 32 having the external toothing 112 formed thereon, together with the rotation-transmitting region 101, are pulled off from the input shaft 28. The broken/sheared connecting region 106 of the second hollow shaft 32 having the external toothing 98 formed thereon can then be removed. In the next step, the remaining part of the hollow shaft 32 is rotated through 180 degrees such that the external toothing 112 formed on the connecting region 108 is brought into meshing engagement with the internal toothing 94 of the second driving bevel gear 42. The clamping ring 130 is mounted again and repositioned so as to abut against the second hollow shaft 32. Once said clamping ring has been fastened in the new position, the second drivetrain 24 has been restored and is operational again.

In the third case, that is to say if the first hollow shaft 30 and the second hollow shaft 32 break or shear, it is necessary for both of the repair steps/maintenance measures described with regard to the first and the second case to be carried out, in any desired sequence.

The drive device that has been described makes it possible, in the event of an overloading-induced failure of the drivetrain(s) 22, 24, for the operator to quickly and inexpensively carry out repair or maintenance measures, and continue operation relatively quickly, even without replacing the hollow shafts 30, 32. Only if the first or the second hollow shaft 30, 32 fails/breaks/shears again would it be necessary to replace these with a new first or second hollow shaft 30, 32.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. The A drivetrain for a drive device, comprising:
an input shaft,
a hollow shaft connected in terms of drive to the input shaft, and
a bevel gear stage connected in terms of drive to the hollow shaft, the bevel gear stage comprising:
a driving bevel gear and a driven bevel gear, the driving bevel gear having a gear hub having an internal toothing which meshes with a first external toothing region extending axially on the hollow shaft,
wherein the first external toothing region is formed on a first connecting region of the hollow shaft, and a rotation-transmitting region of the hollow shaft extends so as to axially adjoin the first connecting region, the rotation-transmitting region forming a rotationally conjoint connection in terms of drive between the input shaft and the first connecting region, and the first connecting region being equipped, between the rotation-transmitting region and the external toothing region, with a first recess that defines a predetermined breaking point.

2. The drivetrain as claimed in claim 1, wherein the hollow shaft comprises a second external toothing region that is not connected in terms of drive to the driving bevel gear, the first and the second external toothing region having the same module, the second external toothing region being formed on a second connecting region of the hollow shaft, which second connecting region extends so as to axially adjoin the rotation-transmitting region, and the rotation-transmitting region of the hollow shaft extending axially between the first and the second connecting region, the rotation-transmitting region forming a rotationally conjoint connection in terms of drive between the input shaft and the two connecting regions, and the first connecting region being equipped, between the rotation-transmitting region and the first external toothing region, with the first recess that defines a predetermined breaking point, and the second connecting region being equipped, between the rotation-transmitting region and the second external toothing region, with a second recess that defines a predetermined breaking point.

3. The drivetrain of claim 1, wherein the first or second recess is formed by an annular groove.

4. The drivetrain of claim 1, wherein the hollow shaft has, in the rotation-transmitting region, an internal profile that engages with a complementary external profile of the input shaft.

5. The drivetrain of claim 1, wherein, in the first or second connecting region of the hollow shaft, a circumferential gap is formed between the internal circumference of the particular connecting region and an external circumference of the input shaft.

6. The drivetrain of claim 1, wherein the hollow shaft is secured axially by a clamping ring which can be positioned axially variably on the input shaft.

7. The drivetrain of claim 1, further comprising a transmission gearbox, the driven bevel gear being connected in terms of drive to the transmission gearbox.

8. The drivetrain of claim 1, wherein the hollow shaft and the input shaft are accessible from outside a gearbox housing, and the bevel gear stage and drivetrain components are situated downstream in the flow of drive power being accommodated in the gearbox housing.

9. A drive device comprising:
at least one drivetrain, including:
an input shaft,
a hollow shaft connected in terms of drive to the input shaft, and
a bevel gear stage connected in terms of drive to the hollow shaft, the bevel gear stage comprising:
a driving bevel gear and a driven bevel gear, the driving bevel gear having a gear hub having an internal toothing which meshes with a first external toothing region extending axially on the hollow shaft,
wherein the first external toothing region is formed on a first connecting region of the hollow shaft, and a rotation-transmitting region of the hollow shaft extends so as to axially adjoin the first connecting region, the rotation-transmitting region forming a rotationally conjoint connection in terms of drive between the input shaft and the first connecting region, and the first connecting region being equipped, between the rotation-transmitting region and the external toothing region, with a first recess that defines a predetermined breaking point.

10. The drive device of claim 9, wherein the at least one drivetrain includes a first and a second drivetrain, and the input shaft is formed as a common input shaft of the first and the second drivetrains.

11. An agricultural machine, comprising:
at least one processing device for processing a crop, and
a drive device connected to the at least one processing device, the drive device having at least one drivetrain, the drivetrain including:
an input shaft,
a hollow shaft connected in terms of drive to the input shaft, and
a bevel gear stage connected in terms of drive to the hollow shaft, the bevel gear stage comprising:
a driving bevel gear and a driven bevel gear, the driving bevel gear having a gear hub having an internal toothing which meshes with a first external toothing region extending axially on the hollow shaft,
wherein the first external toothing region is formed on a first connecting region of the hollow shaft, and a rotation-transmitting region of the hollow shaft extends so as to axially adjoin the first connecting region, the rotation-transmitting region forming a rotationally conjoint connection in terms of drive between the input shaft and the first connecting region, and the first connecting region being equipped, between the rotation-transmitting region and the external toothing region, with a first recess that defines a predetermined breaking point.

12. The agricultural machine of claim 11, wherein the at least one processing device is in the form of a threshing device, chopping device or cutting device.
